(19) United States
(12) Patent Application Publication
(10) Pub. No.: US 2021/0138405 A1
(43) Pub. Date: May 13, 2021

(54) SMART ACTIVE MEMBRANE

(71) Applicant: Osmotex AG, Thalwil (CH)

(72) Inventor: Trond Heldal, Luzern (CH)

(73) Assignee: Osmotex AG, Thalwil (CH)

(21) Appl. No.: 16/476,761

(22) PCT Filed: Jan. 10, 2018
(86) PCT No.: PCT/EP2018/050578

§ 371 Date: Jul. 9, 2019

(30) Foreign Application Priority Data
Jan. 11, 2017 (GB) 1700476.3

(51) Int. Cl. B01D 61/42; G08B 21/08

(52) U.S. Cl. CPC B01D 61/427; B01D 2313/22; B01D 2313/20; G08B 21/088

(57) ABSTRACT

An apparatus comprising: an active membrane, wherein the active membrane transports liquid through the active N membrane when a voltage is applied across the active membrane; and a controller for controlling the active membrane (i.e. controlling operation of the active membrane) are provided. The controller is configured to receive user data, membrane data and external data; and configured to control the active membrane based on one or more of the received user data, membrane data and external data. A system comprising: an apparatus comprising an active membrane, wherein the active membrane transports liquid across the membrane when a voltage is applied across the active membrane; and a server configured to communicate with the apparatus comprising the active membrane is provided. Methods of operating the apparatus and system are also provided.

The present invention relates to a smart active membrane.

Active membranes for transporting liquid across the membrane when a voltage is applied across the active membrane are known. These may be membranes, pumps and textiles, and can be used in a wide range of applications for moisture and liquid flow control. Example application areas include microfluidic pumps, clothing (including leisure, sports, work and protective), medical (wound care, bed ulcer treatment etc.), applications relating to climate control in automobiles, planes and buildings, etc.

It is known to provide an active membrane with a humidity sensor that is used to provide information about wetting or moisture conditions of the active membrane. An electronic control circuit is then designed to provide a voltage to the active membrane only when a certain humidity level is detected, and possibly to adapt the voltage level according to the measured moisture level, for example applying a higher voltage when the humidity or moisture level is higher.

There is however a desire for more monitoring and/or improved control of active membranes.

In a first aspect the present invention provides a method of operating an active membrane, the method comprising: providing an active membrane, wherein the active membrane transports liquid through (at least part of) the active membrane when a voltage is applied across the active membrane; receiving two or more or all of user data, membrane data and external data; and controlling the active membrane based on one or more of the received user data, membrane data and external data.

The receiving and/or controlling steps may be performed using a controller.

In a second aspect the present invention provides an apparatus comprising: an active membrane, wherein the active membrane transports liquid through (at least part of) the active membrane when a voltage is applied across the active membrane; and a controller for controlling the active membrane (i.e. controlling operation of the active membrane), wherein the controller is configured to receive two or more or all of user data, membrane data and external data; and configured to control the active membrane based on one or more of the received user data, membrane data and external data.

It has been realised that that it may be beneficial to receive data from a plurality of different sources and then to control the operation of the active membrane based on one or more of those inputs. This may allow control that is more suited to a user's requirements, based more on the condition of the membrane and/or based more on the external environment. This may improve the experience for the user.

The active membrane may be controlled based on all of the received user data, membrane data and external data.

The idea of having an apparatus comprising an active membrane and connecting it to a server such that data can be sent and/or received from the server is considered to be independently patentable.

Thus, in a third aspect, the present invention provides a system comprising an apparatus comprising an active membrane, wherein the active membrane transports liquid across the membrane when a voltage is applied across the active membrane; and a server configured to communicate with (i.e. receive data from and/or send data to) the apparatus comprising the active membrane.

In a fourth aspect the present invention provides a method, the method comprising providing an apparatus comprising an active membrane, wherein the active membrane transports liquid across the membrane when a voltage is applied across the active membrane; and providing a server configured to communicate with (i.e. receive data from and/or send data to) the apparatus comprising the active membrane.

The method may comprise receiving data from and/or sending data to the apparatus.

The method may be performed using the system. The system may be used to perform the method.

The method and/or system of the third and/or fourth aspect may have any one or more features (including the optional features) of the first or second aspect and vice versa.

For example, the apparatus of the third and/or fourth aspect may be the apparatus of the second aspect. The apparatus of the third and/or fourth aspect may be controlled according to the method of the first aspect.

The following description sets out optional features that may be in combination with the features of any of the aspects of the invention. The following described optional features may be features of the method, apparatus and/or the system.

The active membrane may be part of and/or in a garment (i.e. item worn by a user).

The apparatus and/or system may comprise a power source, a controller (which may include a processor), a communication device, an input and/or output device (which may also be referred to as a user interface), and/or one or more sensors. The active membrane may comprise and/or be connected to one or more of a power source, a controller, a communication device, an input and/or output device, and/or one or more sensors.

The apparatus may comprise a plurality of active membranes. The plurality of active membranes may be associated with a common power source, controller, and/or input and/or output device for example.

For example, the apparatus may comprise a single garment that comprises a plurality of active membranes. These may be patches. These patches may be located to target certain areas of the garment. These patches may be independently controllable.

The apparatus may comprise a communication device for receiving data from and/or sending data to an external source. This may be data about the user and/or the membrane of the apparatus and/or data that is used to control the membrane of the apparatus. The method may comprise communicating with (i.e. sending to or receiving data from) an external source.

The external source may be a server and/or an external electronic device such as a smart phone.

The apparatus and/or system may comprise an active ventilation device.

An active ventilation device may comprise a device for circulating air at, near or around the membrane, such as inside a garment or between a garment and outside air. This may for example be achieved by means of electric fans.

The apparatus may comprise a heating and/or a cooling device (i.e. temperature adjustment device). The active membrane may comprise and/or be in contact with an active heating and/or an active cooling device (such as a heating and/or cooling fabric). Thus each apparatus may comprise a heating and/or cooling device. The controller may also control the active heating and/or an active cooling device. The active heating and/or active cooling devices, as well as being used for temperature control, may be used to help to affect (e.g. induce or accelerate) water transport through the active membrane.

The heating and/or cooling device may use the Peltier effect.

The cooling device may comprise a Peltier cooler, and/or the heating device may comprise a resistive textile element.

The heating and/or cooling device may be used to adjust the temperature of the membrane and/or the user.

The apparatus may be formed from a series of active garments. For example, the apparatus may comprise a garment comprising sensors, a garment comprising the active membrane and/or a garment comprising other active devices such as a heating device. Each garment may be worn by the user, for example on top of each other.

Each active garment may comprise its own power source, electronic unit/controller and/or communication device. Alternatively, the active garments may comprise a common power source, electronic unit/controller and/or communication device.

Controlling the active membrane may comprise controlling fluid flow through the membrane and/or controlling the temperature by controlling the active heating and/or an active cooling device(s), if present.

The apparatus may comprise an electronic unit. The electronic unit may be associated with, e.g. connected to, the active membrane. The electronic unit may for example be integrated into or attached to a garment comprising the active membrane. The electronic unit may comprise a, or part of a, controller.

The controller and/or electronic unit may be arranged to receive data from and/or send data to an external source. This data may be received and/or sent wirelessly (such as via Bluetooth and/or NFC etc.) and/or with wires (such as using a USB connection). The data may be received from and/or send to an external server. There may be two way communications between the apparatus and the external server.

The controller/electronic unit may comprise software and/or algorithms.

This software may use the data to determine how to control the active membrane and any additional components, such as a heating or cooling device, if present.

The controller may be at least part of an external electronic device such as a smart phone, a smart watch, a remote computer etc.

The data (such as user data, membrane data and/or external data) may be received and/or sent (i.e. communicated) via an external electronic device such as a smart phone, a smart watch, a remote computer etc. and/or it may be received and/or sent directly by the controller. The system may comprise a communication device that allows the receiving and/or sending of data from the controller from and/or to an external server.

The external server may be in communication with a plurality of apparatuses that each comprises an active membrane. Thus, the server may receive data from and/or send data to a plurality of active membranes. The server may be an external central server.

The system may thus comprise a plurality of apparatuses comprising active membranes that are each in communication with the central server (e.g. single central server).

The central collection of data from a number of apparatuses may allow one apparatus comprising an active membrane to be controlled based on data received from a different active membrane.

For example, on a ski slope, data from different uses could be used to map the local climate from top to valley. This information could be used to predict the conditions a skier on the slope is about to experience.

Additionally and/or alternatively, data may be logged from many systems over time to reveal patterns in user behaviour. For example, it may be logged how much a user turns on the system at given inner and outer climatic conditions.

The system may be configured so that one apparatus is controlled based on data received from another apparatus.

For example, the server may monitor the locations of all the apparatuses and control at least one of the apparatuses based on data received from another apparatus which is proximal (e.g. within 500 m) to the apparatus being controlled.

The server may be used to centrally collect data about all of the apparatuses. This may be used for troubleshooting and support of one or more of the apparatuses. This may be used to provide feedback to the developers and/or manufacturers to aid the development and manufacture of future products. Thus the data at the server may not be used for control in real time.

The server may permit central control of the all of the apparatuses. For example, certain data may be sent to some or all of the apparatuses to cause them to be controlled in a certain way.

The presence of a server may facilitate additional functionality such as one or more of the following: 1) sending of adverts, tips, warnings and/or information to one or more users from the server; 2) sending of requests for advice or support from one or more users to the server; 3) sharing on social media via the server; 4) communication between apparatuses (e.g. garments comprising the apparatus) in same area, e.g. to make a temperature and humidity map of a ski slope which can be used to anticipate and adapt one or more apparatuses, 5) communication between users of the apparatuses.

The membrane and/or apparatus may comprise a circuit for connection to a power source that allows the supply of electric voltage across the porous membrane.

The power source may be a battery (which may be connected to the membrane). The power source may be connected to/be part of the electronic unit. The power source may be part of an external electronic device such as a smart phone, a smart watch, a remote computer etc. The battery may be in addition to the battery in an external electronic device. The power source may additionally or alternatively an energy harvesting device such as a solar cell or movement energy harvesting.

The power source and/or controller/electronic unit may be connected to the active membrane. This may allow power and/or control of the active membrane.

The membrane (e.g. controller) may be controlled from an external electronic device such as a smart phone, a smart watch, a remote computer etc. The controller may be part of an external device such as a smart phone, a smart watch, a remote computer etc.

For example, the control system may be controlled from a smart phone app.

The power source, controller, one or more sensors and/or a user interface may be provided by an external portable consumer device such as a smart phone, a smart watch etc.

The user data may be data that is input by and/or is about a user. This may for example comprise personal data such as age, gender, weight, height, fitness level. The user data may alternatively or additionally comprise user preference data such as temperature and humidity preferences. The user data may comprise an indication of an activity that the user is about to undertake and/or is undertaking. The user data may be input directly to the apparatus, into an external electronic device, such as a smart phone, and/or provided to and stored on the server.

The membrane data may be data concerning the condition of (e.g. at and/or near (such as within a few centimetres of the membrane)) the membrane. The membrane data for example may comprise humidity, temperature, conductivity and/or impedance of the membrane, detection of water, moisture and/or rain on the membrane, movement, acceleration, deceleration, speed, orientation of the membrane and/or pressure on the membrane etc. The impedance of the membrane may provide information about the humidity content of the membrane and/or whether there is a failure, like a short circuit or circuit break.

The membrane data may be sensor data, i.e. data collected by sensors on, in or near the membrane.

The external data may be data that is not input by or about the user and/or is not data specifically concerning the membrane. For example, the external data may comprise weather data (such as sensed weather conditions or weather forecasts), time and date data, GPS data, data regarding previous use, and/or data from other systems (such as other functional elements worn by the user and/or functional elements worn by other users) etc. The external data may be received from a server.

The temperature at various positions and heights above sea level may be known and/or predicted. The control may be based on this information in combination with knowing the position of the apparatus.

GPS data may be used to predict the conditions that the membrane is in and/or the activity of the user.

The method may comprise collecting one or more (e.g. two or all) of user data, membrane data and external data.

The user data, membrane data and/or external data may be input, sensed and/or received. For example, the system may comprise an input device to permit the input of data, such as user data. The input device may be connected and/or attached to the membrane. The input device may be provided by a separate external electronic device such as smart phone, a smart watch, a remote computer etc. The system may comprise a user interface for providing information to and/or receiving information from a user. Thus, the user interface may provide an input and/or output device.

The controller may be in communication with, or part of, an external electronic device such as smart phone, a smart watch, a remote computer etc. This may be the same device that provides an input device (if present).

The method may comprise sensing a condition. The condition may be one or more of humidity, temperature, conductivity, impedance, detection of water, moisture and/or rain, the weather, acceleration, deceleration, speed, orientation, location, pressure etc. The sensed condition may be the membrane being in contact with a surface such as the ground or a wet object.

The system and/or apparatus may thus comprise one or more sensors. The data may for example be received from a sensor that is part of the system and/or apparatus.

The sensor(s) may comprise one or more of a humidity sensor, temperature sensor, moisture sensor, accelerometer, magnetometer, proximity sensor, pressure sensor, altitude sensor, chemical sensor, GPS sensor etc.

The sensors may be used to sense the membrane data, user data and/or external data.

One or more of the sensor(s) may be connected to the apparatus, part of the apparatus, external and unconnected to the apparatus and/or may be part of an external electronic device such as a smart phone etc.

The sensors may be interchangeable and customizable.

One or more of the sensor(s) may be provided by the active membrane itself. Thus, the active membrane and/or one or both of its conductive layers may be arranged so that it can be used as a sensor.

For example, the electrical impedance of the membrane may depend on its moisture content. This may be due to an increase in conductivity and/or capacitance. The impedance may be measured at the same connectors as those providing the electric voltage for inducing moisture transport in the membrane.

The sensor may be provided by a measuring circuit that measures the electrical impedance of the membrane. The impedance measured by the measuring circuit may depend on the moisture conditions between the conductive layers.

The active membrane may be controlled by controlling the voltage applied to the membrane. For example, the polarity, magnitude and/or duty cycle of the voltage may be controlled.

The voltage may be applied and/or adjusted automatically in response to a sensed condition. This condition may be determined from one or more of the user data, membrane data and/or external data.

The voltage may be automatically applied in response to a signal from a sensor.

For example, the user may input details regarding their planned activity, the system may sense the humidity at the membrane and the system may receive a weather forecast to predict the outside humidity levels and based on this the controller may apply a certain voltage to the active membrane to attempt to achieve a certain humidity level.

The active membrane may comprise: a porous layer; a first electrically conductive layer located on a first side of the porous layer; and a second electrically conductive layer located on a second side of the porous layer.

The active membrane may be arranged such that when an electric voltage is applied between the first and second electrically conductive layer across the porous layer the active membrane transports liquid across the porous layer.

The liquid may be pumped through the active membrane.

The membrane may be a textile and/or pump.

The membrane may be a layered structure made up of a plurality of layers.

The membrane may be a porous membrane. The electrically conductive layers may be electrically conductive porous layers.

The electrically conductive layers may be textiles laminated on each side of the porous layer.

The porous layer may be a non-conductive layer.

The membrane may be an active membrane such as an electroosmotic or electrokinetic membrane.

The electroosmotic membrane may be any structure, such as a fabric, for pumping fluid by electroosmotic transport.

The porous layer may be flexible.

The porous layer may be a polymer porous layer.

The porous layer may have a negative surface charge when wetted.

The porous layer may comprise ionic groups to carry the current, e.g. sulfonic acid groups.

The porous layer may be about 5 to 500 micron, or about 10-120 microns thick (i.e. the dimension through the membrane substantially in the direction of the net fluid flow).

The porous layer may have pores smaller than 500 nm, or less than 5 nm. For example, the pore size may be 0.1 to 200 nm.

The membrane may be combined with fabric layers to form a textile. For example, a wicking layer may be provided on one (such as the second surface) or both surfaces of the active membrane.

The first electrically conductive layer and/or the second electrically conductive layer may be fabric layers with 1 to 30 wt. percent conductive yarn. For example the conductive yarn may be silver coated polyester or steel yarn.

The first electrically conductive layer and/or the second electrically conductive layer may be coated with a capacitive coating.

The membrane may be used in clothing, such as a jacket. The clothing may be outdoor clothing, sports, leisure and/or work clothing. The membrane may be used to give better performance and comfort to the wearer.

The membrane may be used in protective clothing such as bacteriological protective clothing, chemically protective clothing, fire fighting uniforms and/or armour/ballistic protection.

The membrane may be used as a vent in applications such as medical wearable devices, electronic devices (e.g. where moisture should be avoided to reduce corrosion), and automotive applications (for example vents on headlights to avoid condensation on the glass). The membrane may be used instead of passive porous vents.

Whilst it is recited that the invention comprises an active membrane, wherein the active membrane transports liquid through (at least part of) the active membrane when a voltage is applied across the active membrane, in other embodiments, the active membrane may be any active device such as a heating or cooling device, active ventilation, etc. Thus, the disclosure herein is also applicable when the active membrane is replaced by an active device that may be controlled on the basis of a plurality of different inputs of data and/or that can communicate with a server.

Thus the following additional aspects may be provided:

An apparatus comprising: an active device; and a controller for controlling the active device, wherein the controller is configured to receive user data, device data and external data; and configured to control the active device based on one or more of the received user data, device data and external data.

A method of operating an active device, the method comprising: providing an apparatus comprising an active device, receiving two or more of user data, device data and external data; and controlling the active device based on one or more of the received user data, device data and external data.

A system comprising: an apparatus comprising an active device; and a server configured to communicate with the apparatus comprising the active device.

A method, the method comprising: providing an apparatus comprising an active device; and providing a server configured to receive data from and/or send data to the apparatus comprising the active device.

The above recited features, including one or more or all of the optional features, may be applicable to these additional aspects.

Certain preferred embodiments of the present invention will now be described by way of example only with reference to the accompanying drawings, in which:

FIG. 1 is a schematic showing a system comprising a plurality of apparatuses.

FIG. 1 shows schematically a system 1 comprising a plurality of (in this example, three) apparatuses 2.

Each apparatus 2 comprises an active membrane 4. The active membrane 4 comprises a porous layer 6. The porous layer 6 is located between two conductive layers 8. When an electric voltage is applied across the porous layer 6 via the conductive layers 8 water is transported through the active membrane 6.

The electric voltage is provided by a power source 10. Although it is shown in this schematic as being a power source separate from the electronic portable device 12 the power source may alternatively be provided by the electronic portable device.

The electric voltage is provided across the porous membrane 6 using the electric circuit 14.

A controller 16 is provided and is configured to control the operation of the active membrane 4. The controller 16 may comprise a processor to permit the processing of data and to control the active membrane 4 based on the data. Whilst the controller 16 is shown as a component separate from the portable electronic device 12, the controller may be part of the portable electronic device 12.

The controller 16 may be arranged such that it can communicate with the portable electronic device 12.

Each apparatus may comprise a temperature adjustment device 17. This may be a heating and/or cooling device 17. The temperature adjustment device 17 may also be controlled by the controller 16.

The portable electronic device 12 may comprise a user interface that permits the input and output of data to and from the controller 16.

The apparatus 2 may also comprise sensors. For example, the apparatus may comprise a measuring circuit 16 to detect one or more conditions of the membrane 6. The electronic device 12 may additionally and/or alternatively comprise one or more sensors.

Each apparatus 2 may be in communication with a central server 18. Each apparatus 2 may be arranged to send data to and receive data from the central server 18.

The central server 18 may receive information from remote sensors (not shown) and this information may be forwarded onto one or more of the apparatuses 2.

The sensor(s) may comprise one or more of a humidity sensor, temperature sensor, moisture sensor, accelerometer, magnetometer, proximity sensor, pressure sensor, altitude sensor, weather sensor, chemical sensor, and/or GPS sensor etc.

Thus the system 1 may comprise means to obtain data regarding the humidity, temperature, conductivity, impedance, detection of water, moisture and/or rain, weather, acceleration, deceleration, speed, orientation, location, and/or pressure etc.

Each apparatus 2 may be configured to receive user data, membrane data and/or external data.

The user data may be data that is input by and/or is about a user. This may for example comprise personal data such as age, gender, weight, height, fitness level. The user data may alternatively or additionally comprise user preference data such as temperature and humidity preferences. The user data may comprise an indication of an activity that the user is about to undertake and/or is undertaking.

The membrane data may be data concerning the condition of the membrane 6. The membrane data for example may comprise humidity, temperature, conductivity and/or impedance of the membrane, detection of water, moisture and/or rain on the membrane, movement, acceleration, deceleration, speed, orientation of the membrane and/or pressure on the membrane etc. Sensors to provide membrane data may be part of the apparatus 2.

The external data may be data that is not input by or about the user and/or is not data specifically concerning the membrane. For example, the external data may comprise weather data (such as sensed weather conditions or weather forecasts), time and date data, GPS data, data regarding previous use, and/or data from other apparatuses 2 (such as other functional elements worn by the user and/or functional elements worn by other users) etc. Sensors to provide external data may be external to the apparatuses 2.

The controller 16 may be configured to receive the user data, membrane data and/or external data; and may be configured to control the active membrane 6 and/or the temperature adjustment device 17 based on one or more, some or all of the received user data, membrane data and external data.

The server 18 may be arranged to receive date from one apparatus 2 and provide that data to another apparatus 2.

The server 18 may be used to centrally collect data about all of the apparatuses 2. This may be used for troubleshooting and support of one or more of the apparatuses 2. This may be used to provide feedback to the developers and/or manufacturers to aid the development and manufacture of future products.

The server 18 may permit central control of the all of the apparatuses 2. For example, certain data may be sent to some or all of the apparatuses 2 to cause them to be controlled in a certain way.

1. An apparatus comprising:
an active membrane, wherein the active membrane transports liquid through the active membrane when a voltage is applied across the active membrane; and
a controller for controlling the active membrane,
wherein the controller is configured to receive user data, membrane data and external data; and configured to control the active membrane based on one or more of the received user data, membrane data and external data.

2. An apparatus according to claim 1, wherein user data comprises one or more of age, gender, weight, height, fitness level, temperature preference and humidity preference, and/or an indication of an activity that the user will undertake.

3. An apparatus according to claim 1 or 2, wherein the membrane data comprises one or more of humidity, temperature, conductivity and/or impedance of the membrane, detection of water, moisture and/or rain on the membrane, movement, acceleration, deceleration, speed, orientation of the membrane and/or pressure on the membrane.

4. An apparatus according to claim 1, 2 or 3, wherein the external data comprises one or more of weather data, time and date data, GPS data, data regarding previous use, and/or data from other apparatuses.

5. An apparatus according to any preceding claim, wherein the apparatus comprises a heating device and/or a cooling device.

6. An apparatus according to claim 5, wherein the controller is configured to control the heating and/or the cooling device based on one or more of the received user data, membrane data and external data.

7. An apparatus according to any preceding claim, wherein the apparatus comprises a communication device for communicating with an external server.

8. An apparatus according to any preceding claim, wherein the apparatus comprises an external electronic device that provides one or more of the controller, a user interface, power source, communication device for use with the active membrane.

9. An apparatus according to any preceding claim, wherein the active membrane is part of a garment.

10. A method of operating an active membrane, the method comprising:
providing an apparatus comprising an active membrane, wherein the active membrane transports liquid through the active membrane when a voltage is applied across the active membrane;
receiving user data, membrane data and external data; and
controlling the active membrane based on one or more of the received user data, membrane data and external data.

11. A method according to claim 10, wherein the apparatus is an apparatus according to any of claims 1 to 9.

12. A system comprising:
an apparatus comprising an active membrane, wherein the active membrane transports liquid across the membrane when a voltage is applied across the active membrane; and
a server configured to communicate with the apparatus comprising the active membrane.

13. A system according to claim 12, wherein the system comprises a plurality of apparatuses comprising active membranes that are each in communication with the server.

14. A system according to claim 13, wherein the server is configured to centrally collect data about all of the apparatuses.

15. A system according to claim 13 or 14, wherein the server may permit central control of a plurality of the apparatuses.

16. A system according to claim 13, 14 or 15, wherein the system is configured so that one apparatus can be controlled based on data received from another apparatus.

17. A system according to any one of claims 12 to 16, wherein the apparatus comprises a heating and/or a cooling device.

18. A system according to any one of claims 12 to 17, wherein the active membrane is part of a garment.

19. A system according to any one of claims 12 to 18, wherein the apparatus is an apparatus according to any of claims 1 to 9.

20. A method, the method comprising:
providing an apparatus comprising an active membrane, wherein the active membrane transports liquid across the membrane when a voltage is applied across the active membrane; and
providing a server configured to receive data from and/or send data to the apparatus comprising the active membrane.

21. A method according to claim 20, wherein the apparatus and server together provide a system and wherein the system is a system according to any of claims 12 to 19.
